(19) United States
(12) Patent Application Publication
(10) Pub. No.: US 2010/0106689 A1
(43) Pub. Date: Apr. 29, 2010

(54) Methods, Computer Program Products, and Systems for File Retention

(75) Inventor: Nicholas Steven Huslak, Johns Creek, GA (US)

Correspondence Address: AT&T Legal Department - PK;Attn: Patent Docketing, One AT&T Way, Room 2A-207, Bedminster, NJ, 07921, US

(73) Assignee: AT&T INTELLECTUAL PROPERTY I, L.P., Wilmington, DE (US)

(21) Appl. No.: 12/257,737

(22) Filed: Oct. 24, 2008

(51) Int. Cl. G06F 17/30

(52) U.S. Cl. 707/662; 707/E17.005; 707/E17.01

(57) ABSTRACT

File retention is performed based on a retention attribute. Information indicating creation of an electronic file is received, and a retention attribute is generated for the electronic file. The retention attribute indicates how long the electronic file should be retained. Retention of the electronic file is monitored based on the retention attribute. The retention attribute may indicate a minimum time period for retaining the electronic file and/or a maximum time period for retaining the file. The electronic file may be automatically destroyed after the maximum time period for retaining the file, or an indication may be provided whether to retain or destroy the electronic file based on the retention attribute and how long the electronic file has been retained Retention of hard copies of electronic files may be performed in a similar manner.

### BACKGROUND

Exemplary embodiments relate to data processing, and, more particularly, to file retention.

Many companies and other organizations have file retention policies specifying how files should be retained and in what manner files should be retained. For example, some files, such as contracts, requests for proposals, and other important documents, need to be retained for a certain amount of time and then destroyed. The policies for destroying the files may be very complicated, ranging from overwriting electronic copies of the files several times to shredding paper copies of the file.

Unfortunately, the file retention policies are often very difficult to implement from the perspective of individuals, such employees or contractors. Each file created by a person may be governed by a policy indicating when the file should be destroyed. It is typically up to the individual user who creates a file to keep track of the policy governing retention of the file. With the typical user creating a large number of files, this can be a time-consuming process that takes away from the person's productivity in completing other tasks. The process becomes even more time-consuming as there are typically several copies of the file at various locations and in various forms throughout an organization. For example, there may be electronic files on laptops that may be carried home, files on desktop computers that may be in various locations throughout the organization, and paper copies of the files in filing cabinets in various locations.

Also, the process for destroying documents is typically not uniformly carried out by every person in an organization that creates files. Thus, some files that should be destroyed end up being retained, thus taking up storage resources unnecessarily. Also, some files that should not be destroyed end up being destroyed, which can have adverse consequences for the organization.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to an exemplary embodiment, a method for performing file retention is provided. The method comprises receiving information indicating creation of at least one electronic file and generating at least one retention attribute for the electronic file. The retention attribute indicates how long the electronic file should be retained, for example, by indicating the latest date by which the electronic file must be deleted. The method further comprises monitoring retention of the electronic file based on the retention attribute, including determining how long the electronic file has been retained. The retention attribute may indicate a minimum time period and/or a maximum time period to retain the electronic file. The retention attribute may be generated responsive to a selection of a value or automatically, based on a predetermined policy. Information indicating the retention attribute for the electronic file and information indicating how long the electronic file has been retained is presented, and information is received indicating whether the electronic file should be retained or destroyed based on the presented information.

According to another embodiment, a computer program product is provided having a computer readable medium with encoded instructions. The encoded instructions, when executed by a computer, cause the computer to receive information indicating creation of at least one electronic file and generate at least one retention attribute for the electronic file. The retention attribute indicates how long the electronic file should be retained. The encoded instruction further cause the computer to monitor retention of the at least one electronic file, including determining how long the electronic file has been retained. The retention attribute may indicate a minimum time period and/or a maximum time period to retain the electronic file. The retention attribute may be generated responsive to a selection of a value for the retention attribute or automatically, based on a predetermined policy. The instructions further cause the computer to present information indicating the at least one retention attribute for the electronic file and information indicating how long the electronic file has been retained and receive information indicating whether the electronic file should be retained or destroyed based on the presented information.

According to another embodiment, a file retention system is provided. The file retention system comprises an input for receiving information indicating creation of at least one electronic file and a processor for generating at least one retention attribute for the electronic file. The retention attribute indicates how long the at least one electronic file should be retained. The processor further monitors retention of the at least one electronic file based on the retention attribute, including determining how long the electronic file has been retained The retention attribute indicates a minimum time period and/or a maximum time period to retain the electronic file. The retention attribute may be generated responsive to a selection of a value for the retention attribute or automatically, based on a predetermined policy. The system further comprises an output for presenting information indicating the at least one retention attribute for at least one electronic file and information indicating how long the electronic file has been retained. The input receives information indicating whether the electronic file should be retained or destroyed based on the presented information.

Other methods, computer program products, and/or systems according to various embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 illustrates an environment in which file retention may be implemented according to exemplary embodiments;

FIG. 2 illustrates a user interface that may be used for file retention according to exemplary embodiment;

FIG. 3 is a flowchart illustrating a process for file retention according to an exemplary embodiment;

FIG. 4 illustrates a file retention system according to exemplary embodiments.

### DETAILED DESCRIPTION

Exemplary embodiments will be described more fully hereinafter with reference to the accompanying figures, in which embodiments are shown. This invention may, however, be embodied in many alternate forms and should not be construed as limited to the embodiments set forth herein.

Exemplary embodiments are described below with reference to block diagrams and/or flowchart illustrations of methods, apparatus (systems and/or devices) and/or computer program products. It should be understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, digital signal processor and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a processor of the computer and/or other programmable data processing apparatus to function in a particular manner, such that the instructions stored in the computer-readable memory produce an article of manufacture including instructions which implement the function/act as specified in the block diagrams and/or flowchart block or blocks.

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, exemplary embodiments may be implemented in hardware and/or in software (including firmware, resident software, micro-code, etc.) that runs on a processor such as a digital signal processor, collectively referred to as “circuitry” or “a circuit”. Furthermore, exemplary embodiments may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate or transport the program for use by or in connection with the instruction execution system, apparatus, or device.

The computer-usable or computer-readable medium may be, for example but not limited to, an electronic, magnetic, optical, electromagnetic or semiconductor system, apparatus or device. More specific examples (a non-exhaustive list) of the computer-readable medium would include the following: a portable computer diskette, a random access memory (RAM), a read-only memory (ROM), an erasable programmable read-only memory (EPROM or Flash memory), and a portable optical and/or magnetic media, such as a flash disk or CD-ROM.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

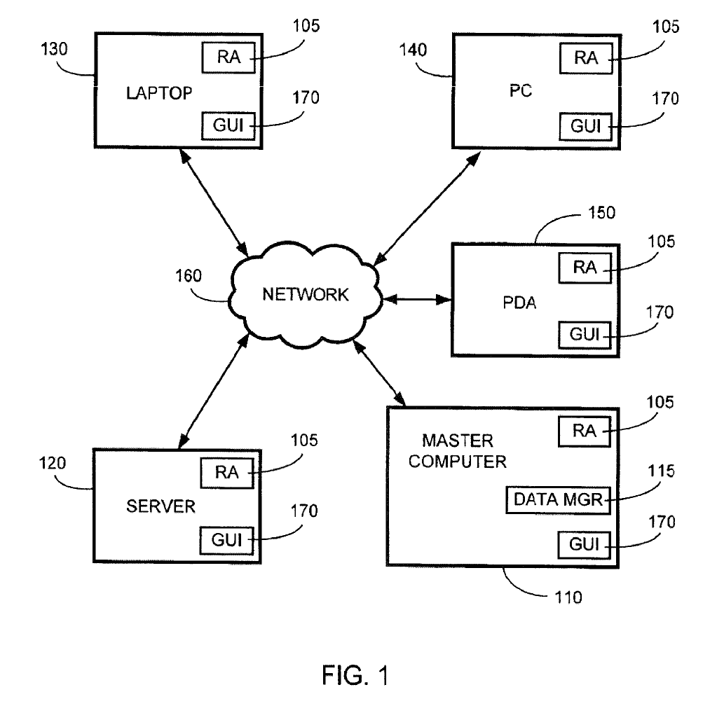

FIG. 1 illustrates an environment in which file retention may be implemented according to exemplary embodiments. In the environment shown in FIG. 1, various devices, including, e.g., a laptop 130, a personal computer (PC) 140, a personal digital assistant (PDA) 150, a server 120, and a master computer 110 are connected via a network 160. The network 160 may be a private network, a public network, or a combination thereof, and may be implemented as an Internet Protocol (IP) based network or in compliance with another network protocol. For example, the network 160 may include a local area network (LAN), a wide area network (WAN), the Internet, or a combination thereof. It should be appreciated that the devices shown in FIG. 1 connected to the network 160 are examples of devices that may be used in a file retention environment and are depicted for illustrative purposes. The file retention environment may include any device capable of storing an electronic file.

According to exemplary embodiments, a file retention application module 105 may be loaded onto one or all of the devices 110, 120, 130, 140, and 150 for managing file retention. If the file retention application 105 is used on multiple devices, one device, such as the master computer 110, may merge and manage data from all of the other devices using a data manager 115. The data may be received by the master computer 110 from the other devices 120, 130, 140, and 150 via the network 160 or some other data transfer/coordination technology. Thus, in the environment shown in FIG. 1, the devices 120, 130, 140, and 150 communicate with the master computer 110 which, in turn, manages file retention on each of the devices 120, 130, 140, and 150 in coordination with the file retention application modules 105. So, for example, if a file is deleted from one of the local devices, e.g., the laptop 130, that device communicates with the master computer 110, and the master computer 110, in turn, communicates with the other devices 120, 140, and 150 to ensure that the file is deleted from those devices, as appropriate. Similarly, when a file is created or deleted from a network storage device, such as the server 120, that device communicates with the master computer 110, which, in turn communicates with the other devices 130, 140, and 150, as appropriate. As an alternative, the file retention application 105 may be included only on the master 110 computer or only on some of the devices 120, 130, 140 and 150.

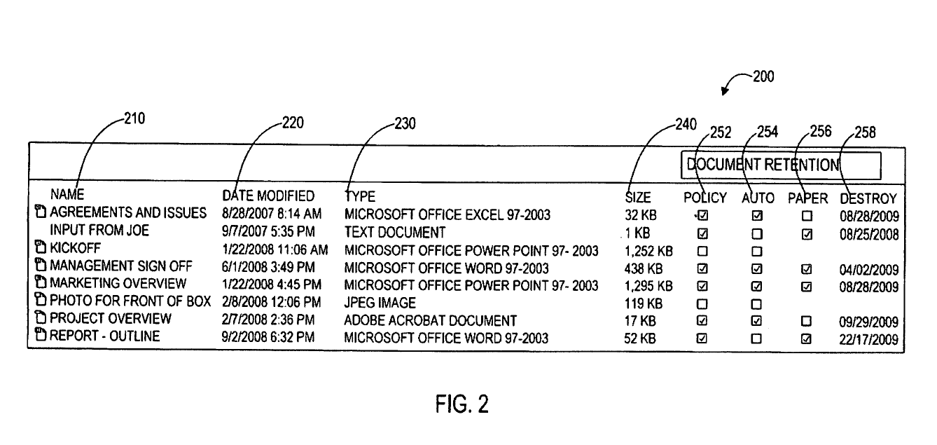

According to an exemplary embodiment, each time a file is created the file retention module 105 prompts the user to enter retention data. The user may be prompted via a user interface, such as graphical user interfaces (GUIs) 170, to enter information relating to file retention. Some of the retention data fields may be pre-populated by the file retention application in accordance with company policy for default file retention policy. The user may also be prompted to enter or update the retention data when a file is modified, subject to the same constraints and company policy that exist for new files. Details of an exemplary user interface are shown in FIG. 2

As shown in FIG. 2, the user interface may include a screen 200. The screen 200 includes a field 210 indicating the name of one or more files. The entries in this field also provide some indication as to the type(s) of the file(s). For example, a text document may be represented with an icon indicating it is a text document, and an Adobe document may be represented with an icon indicating it is an Adobe document. The screen 200 may also include a field 230 that expressly defines the type(s) of file(s). Types of electronic files may include, for example, Word documents, emails, spreadsheets, PDFs, and power points documents. A field 220 indicates when the file(s) were created/modified, e.g., by date and time. A field 240 indicates the size(s) of the file(s).

When file creation/modification occurs, the user may be prompted to enter or update file retention data via fields 252, 254, 256, and 258. In the field 252, the user may enter a “check mark” or some other indicator to indicate that there is a file retention policy associated with the file. In the field 254, the user may enter a “check mark” to indicate that the file is to be automatically destroyed upon expiration of the retention time. In the field 256, the user may enter a “check mark” to indicate that there is a hard or “paper” copy of the file.

The “check marks” depicted in FIG. 2 may be initially set automatically by the retention application. Those settings that the company policy does not allow to be modified may be “grayed out” to indicate that the user cannot change them. Thus, for example, the user interface 200 may have some policy entry portions “grayed out” and “check-marked” in advance to indicate that a particular file is governed by a company policy, and the user is not allowed to disassociate the file from the company policy.

The “paper” field 256 may be populated with an indicator, such as a “check mark” or a number indicating the number of outstanding hardcopies. The user may enter the number of hard copies or enter a “check mark” to indicate that hard copies exist. As an alternative, the retention application 105 may keep track of paper copies and automatically populate this field. For example, the file retention application 105 may initially set this field to “zero” indicating there are no paper copies available and then update the number each time the file is sent for printing. As yet another alternative, the user may alter the number of paper copies indicated in this field, e.g., each time a hard copy of the file is copied or destroyed.

FIG. 2 also shows the field 258 indicating a time, e.g., date, to destroy the file. This corresponds to the maximum time that the file should be retained. For convenience, this information may be prepopulated with default data according to preset policy, e.g., company policy. As an alternative, the user may enter a date to destroy the document in the field 258. Although not shown in FIG. 2 for simplicity of illustration, there may also be a field in which the user may enter information indicating a minimum time that the document should be retained.

According to an exemplary embodiment, the user interface may also provide additional options for users. These options may be provided, e.g., upon setup of the file retention application. For example, for the actual carrying through of the file deletion, the user may be given a choice to delete all eligible files automatically according to the set retention policy. As another option, the user may be given a choice to delete all eligible files automatically unless the user checks a “delete manually” box (in which case, the user may request to be notified before a file is deleted). The user may also indicate whether he or she wants to be notified when files are nearing deletion dates, provided with a list of files eligible for deletion and indicate how often such a list should be provided, e.g., every day, once a week, or once a month. The user may also indicate that he/she would like to make the final selection regarding which files to delete and would like to be able to modify the deletion date (if supported by company policy).

The file retention application 105 may keep a file retention list including much of the information shown in the fields in FIG. 2. This list may be monitored on demand or on a periodic basis, such as every morning at 3:00 am when usage of organization resources is low. Alternatively, the list may be monitored continuously. The file retention application 105 may monitor the list of documents and, depending upon the user's preferences, present the user with a list of files that are eligible or scheduled for deletion within a given time period, e.g., a week, several hours, or immediately. This list may be presented via a user interface, such as that shown in FIG. 2 in a number of different formats. For example, the list may show all files in a particular directory, all files in a particular directory that are nearing their corresponding deletion date(s), and a global list drawn from the entire file system showing with only those files that are nearing the deletion date being highlighted. Alternatively, the list may be presented by any other appropriate means, e.g., an email indicating files that are nearing deletion. Based on user selectable options, the file retention application may automatically implement company policy for files that require deletion, either with or without user confirmation.

According to exemplary embodiments, the retention application may be integrated with file management utilities (both stand-alone, e.g., Windows Explorer®, and utilities that are bundled into other programs, such as file menus in a Microsoft Office application). The integration with the file management utility includes the support of new fields in the file listing that present file retention system information to the user.

According to one embodiment, file retention may be extended to cover not just final versions of files but also draft versions or earlier versions. These may be marked for deletion at the same or an earlier time than the later or final version. For example, a document management system may assign a unique serial number to each newly created file with further indicators, such as v1, v2, v3, to indicate a version of the document.

Destroying a file may include archiving the file or entirely destroying the file. This may depend on Department of Defense protocols for destroying documents. According to these protocols, some documents have to be literally destroyed such that they are not recoverable. For example, a paper copy of a file that has reached its deletion date may not just need to be thrown away but may need to be actually “shredded” that has reached its deletion date may need to be deleted in such a way that the storage space previously used to store the file is overwritten, e.g., a certain number of times with pseudo-random data.

According to exemplary embodiments, the file retention application makes it easier to comply with Department of Defense protocol for destroying hard copy and electronic copy documents and reduces liability for companies and other organizations by reducing the number of documents that are discoverable. Also, the file retention application reduces the number of resources needlessly used for storing paper and electronic files that should be destroyed.

As described above, hard “paper” copies of files may also be subject to file retention policies in a manner similar to that provided for electronic copies of files. An issue with retention management of hard copies is that hard copies are often passed on to new “owners”, and it is difficult to keep track of where hard copies are at a given time. According to an exemplary embodiment, the file retention application 105 may keep track of the new owners in these cases by either logging the transfer information automatically if available (e.g., when the owner emails a copy or if the server software identifies the downloading of a file by a user) or by prompting the original owner for the new owner's name (e.g., when the document is sent to the printer, or if the server software does not identify the downloading user). Some time before the date for deleting the file, e.g., a week before the scheduled deletion date, the retention application 105 may send an email to each of the “owners” of hard copies of the file, reminding them of the upcoming deletion date. If, according to company policy, the original owner is still responsible for such paper or electronic copies, the retention module may issue a report to the original owner indicating where all of the copies to be destroyed can be found.

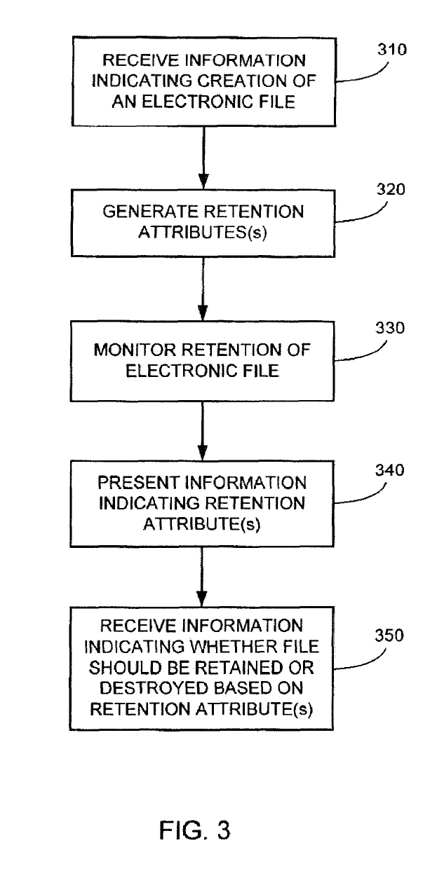

FIG. 3 is a flowchart illustrating a method for file retention according to an exemplary embodiment. At step 310, information indicating creation of at least one electronic file is received. This information may be received by a file retention application, such as the file retention application 105, in one or more of the devices 110, 120, 130, 140, and 150. In one embodiment, one or more of the devices 110, 120, 130, 140 and 150 generates this information. In another embodiment, the master computer 110 receives this information from one or more of the devices 120, 130, 140 and 150. At step 320, at least one retention attribute is generated for the electronic file, indicating how long the electronic file should be retained. The retention attribute is generated by the retention application 105 based on information input via the user interface shown in FIG. 2 or information automatically provided according to company policy. At step 330, retention of the electronic file is monitored based on the retention attribute, including determining how long the electronic file has been retained. This monitoring is performed by the retention application 105. At step 340, information indicating the at least one retention attribute for the electronic file and information indicating how long the electronic file has been retained are presented. This information may be presented as a report to a user via a user interface, such as the user interface 170. At step 350, information indicating whether the electronic file should be retained or destroyed based on the presented information is received. This information may be received from a user via the user interface 170.

As an alternative to steps 340 and 350, rather than presenting information to a user and receiving information indicating whether a file should be retained or destroyed, the retention application 105 may automatically cause the file to be retained or destroyed, e.g., after a maximum time period for retaining the file has been reached.

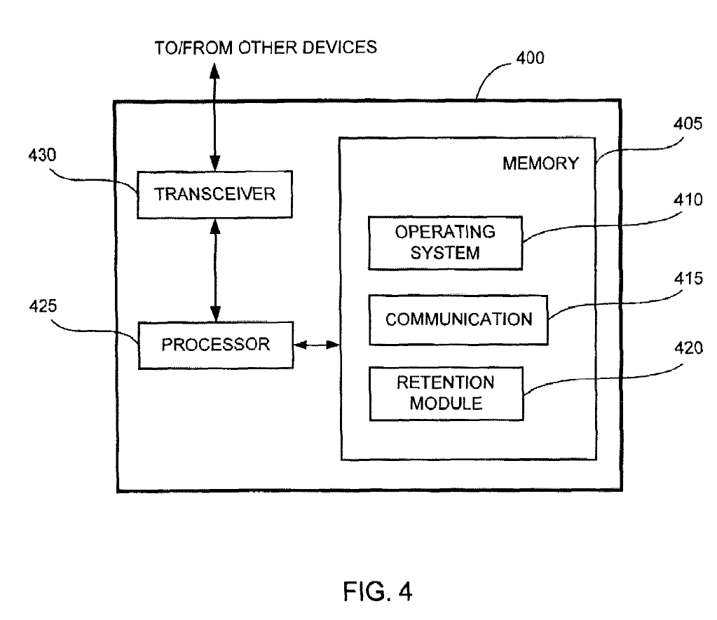

FIG. 4 illustrates an exemplary system for performing file retention according to an exemplary embodiment. In some embodiments, the file retention system may be included in multiple devices, e.g., the devices 110, 120, 130, 140, and 150 shown in FIG. 1. In other embodiments, the file retention system may be included only in a master computer, e.g., the master computer 110, which is in communication with other devices. Also, the file retention system may be included in some devices and not in others.

Referring now to FIG. 4, a file retention system 400 includes a processor 425, a transceiver 430, and a memory 405. The processor 425 communicates with the memory 405 via an address/data bus. The processor 425 may be, for example, a commercially available or custom microprocessor. The memory 405 is representative of the one or more memory devices containing the software and data used to facilitate file retention in accordance with some embodiments. The memory 405 may include, but is not limited to, the following types of devices: cache, ROM, PROM, EPROM, EEPROM, flash, SRAM, and DRAM. The transceiver 440 includes a transmitter circuit and a receiver circuit, which are used to establish and maintain communication with another device.

As shown in FIG. 4, the memory 405 may contain multiple categories of software and/or data: an operating system 410, a communication module 415, and a retention module (also referred to as a retention “application”) 420. The operating system 410 generally controls the operation of the retention module 420. In particular, the operating system 410 may manage the retention module's software and/or hardware resources and may coordinate execution of programs by the processor 425. The communication module 415 may be configured to manage the communication protocols, including both wireless and wireline protocols, that are used by the transceiver 430 to communicate with other devices in the file retention environment via a network, such as the network 160 shown in FIG. 1.

Although FIG. 4 illustrates an exemplary system for performing file retention in accordance with some embodiments, it will be understood that the present invention is not limited to such a configuration but is intended to encompass any configuration capable of carrying out operations described herein.

Computer program code for carrying out operations of devices, terminals, and/or systems discussed above with respect to FIGS. 1-4 may be written in a high level programming language, such as Java, C, and/or C++, for development convenience. In addition, computer program code for carrying out operations of embodiments may also be written in other programming languages, such as, but not limited to, interpreted languages. Some modules or routines may be written in assembly language or even micro code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Exemplary embodiments are described herein with reference to message flow, flowchart and/or block diagram illustrations of methods, devices, and/or computer program products. These message flow, flowchart and/or block diagrams further illustrate exemplary operations for performing file retention in accordance with various embodiments. It will be understood that each message/block of the message flow, flowchart and/or block diagram illustrations, and combinations of messages/blocks in the message flow, flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the message flow, flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the message flow, flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow, flowchart and/or block diagram block or blocks.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method for performing file retention, comprising:
receiving information indicating creation of at least one electronic file;
generating at least one retention attribute for the electronic file, wherein the retention attribute indicates how long the electronic file should be retained; and
monitoring retention of the electronic file based on the retention attribute, including determining how long the electronic file has been retained.

2. The method of claim 1, wherein the at least one retention attribute indicates at least one of a minimum time period to retain the electronic file and a maximum time period to retain the electronic file.

3. The method of claim 1, wherein the at least one retention attribute is generated responsive to a selection of a value for the retention attribute or is automatically generated based on a predetermined policy.

4. The method of claim 1, further comprising:
presenting information indicating the at least one retention attribute for the electronic file and information indicating how long the electronic file has been retained; and
receiving information indicating whether the electronic file should be retained or destroyed based on the presented information.

5. The method of claim 2, wherein the electronic file is automatically destroyed after the electronic file has been retained for the maximum time period.

6. The method of claim 1, further comprising:
generating at least one hard copy retention attribute for a hard copy of the electronic file, wherein the hard copy retention attribute indicates how long the hard copy of the electronic file should be retained; and
monitoring retention of the hard copy of the electronic file based on the hard copy retention attribute, including determining how long the hard copy has been retained.

7. The method of claim 6, further comprising:
presenting information indicating the at least one hard copy retention attribute for the hard copy the electronic file and information indicating how long the hard copy of the electronic file has been retained; and
receiving information indicating whether the hard copy of the electronic file should be retained or destroyed based on the presented information.

8. A computer program product comprising a computer readable medium having encoded instructions that, when executed by a computer, cause the computer to:
receive information indicating creation of at least one electronic file;
generate at least one retention attribute for the electronic file, wherein the retention attribute indicates how long the electronic file should be retained; and
monitor retention of the at least one electronic file, including determining how long the electronic file has been retained.

9. The computer program product of claim 8, wherein the retention attribute indicates at least one of a minimum time period to retain the electronic file and a maximum time period to retain the electronic file.

10. The computer program product of claim 8, wherein the retention attribute is generated responsive to a selection of a value for the retention attribute or is automatically generated based on a predetermined policy.

11. The computer program product of claim 8, wherein the instructions further cause the computer to:
present information indicating the at least one retention attribute for the electronic file and information indicating how long the electronic file has been retained; and
receive information indicating whether the electronic file should be retained or destroyed based on the presented information.

12. The computer program product of claim 9, wherein the electronic file is automatically destroyed after the electronic file has been retained for the maximum time period.

13. The computer program product of claim 8, wherein the instruction further cause the computer to:
generate at least one hard copy retention attribute for a hard copy of the electronic file, wherein the hard copy retention attribute indicates how long the hard copy of the electronic file should be retained; and
monitor retention of the hard copy of the electronic file based on the hard copy retention attribute, including determining how long the hard copy has been retained.

14. The computer program product of claim 13, wherein the instructions further cause the computer to:
present information indicating the at least one hard copy retention attribute for the hard copy the electronic file and information indicating how long the hard copy of the electronic file has been retained; and
receive information indicating whether the hard copy of the electronic file should be retained or destroyed based on the presented information.

15. A file retention system comprising:
an input for receiving information indicating creation of at least one electronic file; and
a processor for generating at least one retention attribute for the electronic file, wherein the retention attribute indicates how long the at least one electronic file should be retained, and the processor further monitors retention of the at least one electronic file based on the retention attribute, including determining how long the electronic file has been retained.

16. The system of claim 15, wherein the at least one retention attribute indicates at least one of a minimum time period to retain the electronic file and a maximum time period to retain the electronic file.

17. The system of claim 15, wherein the at least one retention attribute is generated responsive to a selection of a value for the retention attribute or is automatically generated based on a predetermined policy.

18. The system of claim 15, further comprising:
an output for presenting information indicating the at least one retention attribute for at least one electronic file and information indicating how long the electronic file has been retained, wherein the input receives information indicating whether the electronic file should be retained or destroyed based on the presented information.

19. The system of claim 16, wherein the processor generates at least one hard copy retention attribute for a hard copy of the electronic file, wherein the hard copy retention attribute indicates how long the hard copy of the electronic file should be retained, and the processor monitors retention of the hard copy of the electronic file based on the hard copy retention attribute, including determining how long the hard copy has been retained,
wherein the output presents information indicating the at least one hard copy retention attribute for the hard copy the electronic file and information indicating how long the hard copy of the electronic file has been retained, and
wherein the input receives information indicating whether the hard copy of the electronic file should be retained or destroyed based on the presented information

20. The system of claim 15, wherein copies of the electronic file are retained on multiple devices, the processor is included in at least one of the multiple devices, and actions performed by the processor are applied to all the copies of the electronic file.
